(19) United States
(12) Patent Application Publication
(10) Pub. No.: US 2013/0241164 A1
(43) Pub. Date: Sep. 19, 2013

(54) CARRIER DEVICE AND METHOD FOR CARRYING ARTICLE

(71) Applicant: FUJITSU LIMITED, Kawasaki-shi (JP)

(72) Inventor: Hajime Wakabayashi, Tagata (JP)

(73) Assignee: FUJITSU LIMITED, Kawasaki-shi (JP)

(21) Appl. No.: 13/756,976

(22) Filed: Feb. 1, 2013

(30) Foreign Application Priority Data
Mar. 14, 2012 (JP) 2012-057932

(51) Int. Cl. B62B 1/00

(52) U.S. Cl. CPC B62B 1/00
USPC 280/47.17

(57) ABSTRACT

A carrier device includes a main body, a handle provided to the main body, an engaging unit provided to the main body and configured to be engaged with a foot provided at a lower end of an article to be carried, and a caster provided to the main body.

### CROSS-REFERENCE TO RELATED APPLICATION

This application is based upon and claims the benefit of priority of the prior Japanese Patent Application No. 2012-057932, filed on Mar. 14, 2012, the entire contents of which are incorporated herein by reference.

### FIELD

The embodiments discussed herein are related to a carrier device and a method for carrying an article.

### BACKGROUND

In general, a carrier device for a cart on casters is known as an example of an article carrier device. A conventional carrier device includes a handle unit, a support rod, and a coupling unit for towing. The coupling unit for towing is inserted into a square hole provided on the cart on casters, thereby being coupled to the cart on casters. Here, an article to be carried (a load) is put on the cart on casters.

In the carrier device for a cart on casters as described above, it is possible to carry an article by towing the cart on casters by holding the handle unit.

However, if a large article, for example, a large box such as a server, is tried to be moved by using the carrier device for a cart on casters, it is difficult to put the article on the cart on casters. The article is not carried if the article is not put on the cart on casters.

When a large box such as a server is carried, an oil-hydraulic lifter may be used. However, the oil-hydraulic lifter is normally large itself, taking up a lot of room for handling, and therefore fine adjustment of an installation position (steering) in a narrow space is difficult.

When a large box is moved, casters included in the box itself can be used without using a special carrier device. However, it is rare for the box to include a handle usable at the time of moving. Without a handle, an operator has to move and steer the box by attaching his or her hands on outer wall surfaces of the box. Steering is difficult at the time of moving with hands attached on the outer wall surfaces. Also, at the time of steering, decorative laminate boards forming the outer walls of the box may be dented. Moreover, when the box is moved only by man power, one or more operators are normally needed.

Here, Japanese Laid-open Patent Publication No. 2005-324642 is an example of related art.

### SUMMARY

According to an aspect of the embodiment, a carrier device includes a main body, a handle provided to the main body, an engaging unit provided to the main body and configured to be engaged with a foot provided at a lower end of an article to be carried, and a caster provided to the main body.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a perspective view of a carrier device of a first embodiment;

FIG. 2A is a side view of the carrier device of the first embodiment;

FIG. 2B is a rear view of the carrier device of the first embodiment;

FIG. 3 is a perspective view of an engaging unit included in the carrier device of the first embodiment;

FIG. 4 is a diagram for describing the state in which an angle adjusting plate is inserted into the engaging unit;

FIG. 5 is an enlarged descriptive diagram of the periphery of the engaging unit provided to a main body unit via an arm member provided at a lower end of the main body unit;

FIG. 6A to FIG. 6C are diagrams for describing the use state of the carrier device of the first embodiment on a time-series basis;

FIG. 7A is a diagram for describing the state in which the engaging unit is about to be inserted into a lower position of a foot;

FIG. 7B is a diagram for describing the state in which the engaging unit has been inserted into the lower position of the foot;

FIG. 8 is a sectional view depicting the state in which the engaging unit has been inserted into the lower position of the foot;

FIG. 9 is a sectional view depicting the state in which a grounding unit of the foot abuts on an angle adjusting plate placed on the engaging unit;

FIG. 10 is a diagram describing a fulcrum, a point of effort, and a point of load when the carrier device of the first embodiment is used;

FIG. 11 is a perspective view of an engaging unit of a second embodiment;

FIG. 12A to FIG. 12C are diagrams for describing the use state of the carrier device of the second embodiment on a time-series basis;

FIG. 13 is a sectional view depicting the state in which an engaging unit has been inserted into a lower position of a foot;

FIG. 14 is a sectional view depicting the state in which the engaging unit is engaged with a grounding unit of the foot;

FIG. 15A is a diagram for describing a carrier device of a third embodiment; and

FIG. 15B is a diagram for describing the carrier device of the third embodiment at the time of towing.

### DESCRIPTION OF EMBODIMENTS

Hereinafter, embodiments of the present disclosure are described with reference to the attached drawings. Note that the dimensions, ratio, and others of each component in the drawings may not perfectly match the actual ones.

### First Embodiment

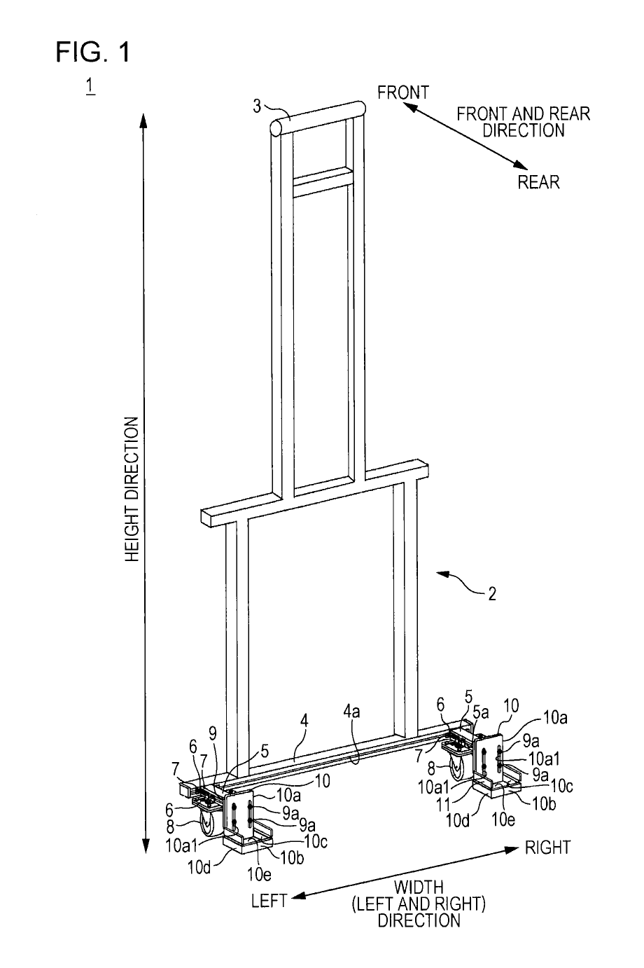

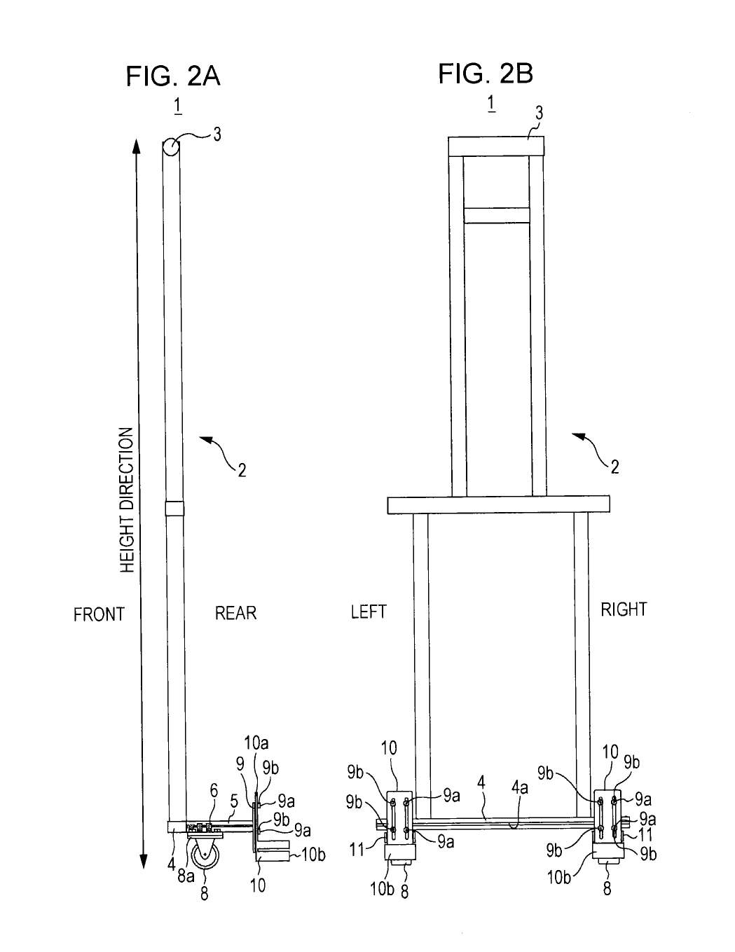

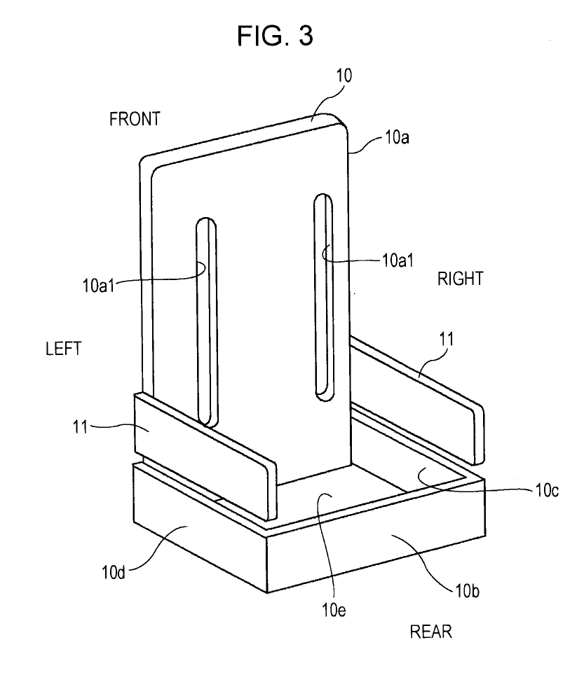

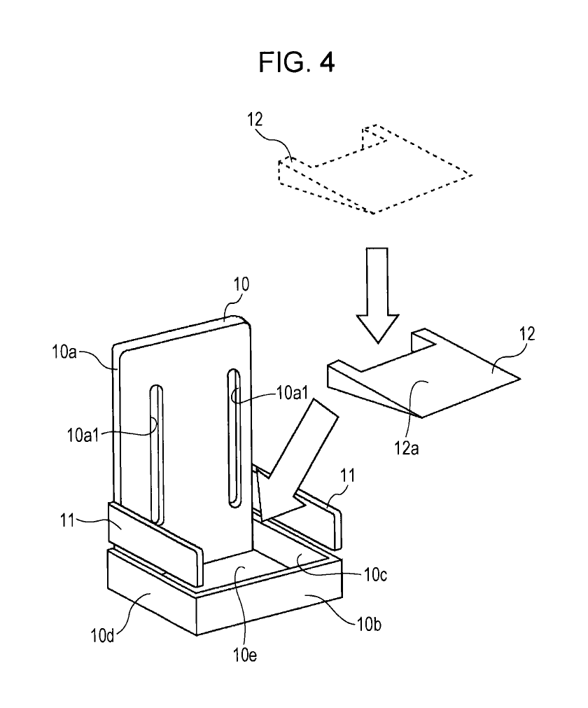

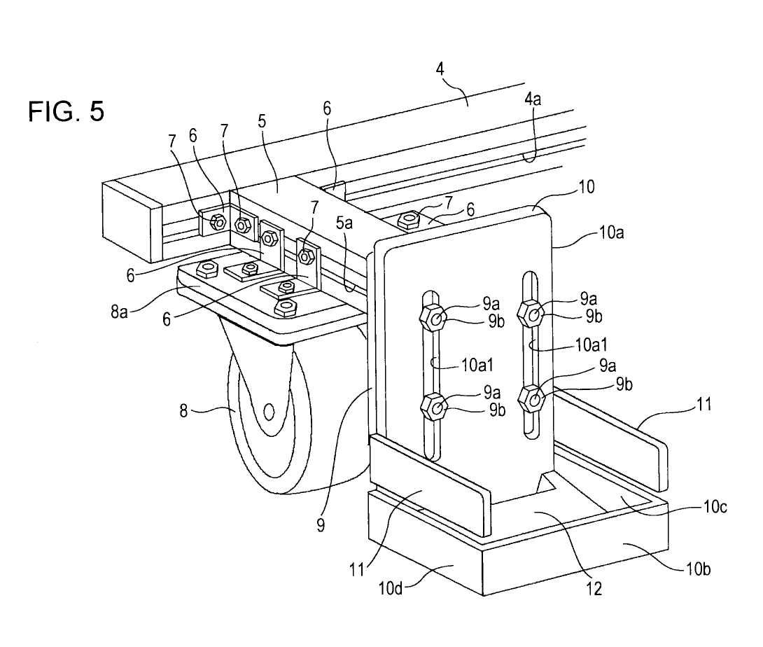

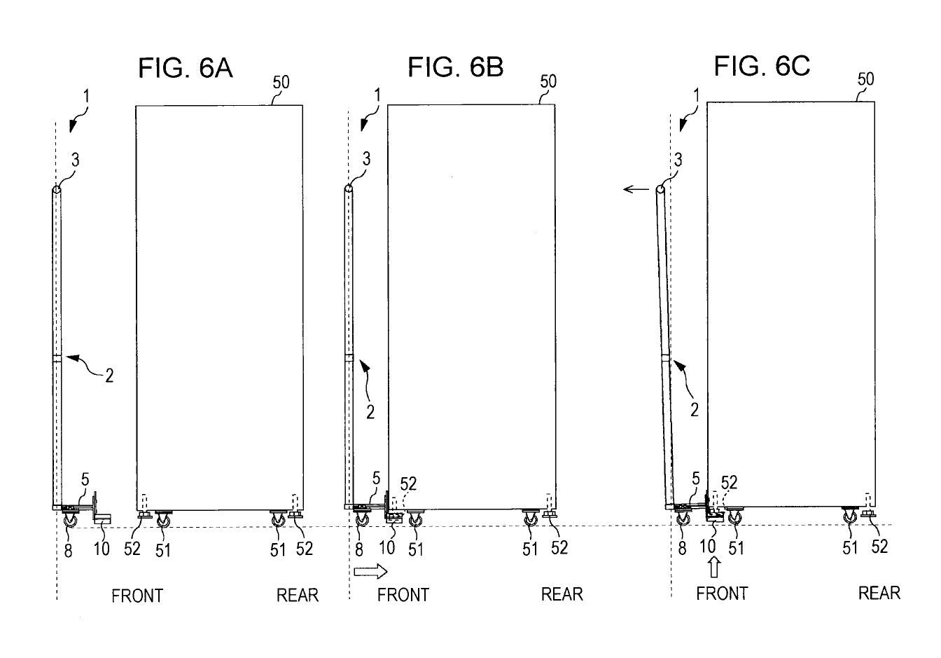

FIG. 1 is a perspective view of a carrier device 1 of a first embodiment. FIG. 2A is a side view of the carrier device 1 of the first embodiment. FIG. 2B is a rear view of the carrier device 1 of the first embodiment. FIG. 3 is a perspective view of an engaging unit 10 included in the carrier device 1 of the first embodiment. FIG. 4 is a perspective view for describing the state in which an angle adjusting plate 12 is inserted into the engaging unit 10. FIG. 5 is an enlarged descriptive diagram of the periphery of the engaging unit 10 provided to a main body unit 2 via an arm member 5 provided at a lower end of the main body unit 2. FIG. 6A to FIG. 6C are diagrams for describing the use state of the carrier device 1 of the first embodiment on a time-series basis.

Prior to description of the carrier device 1 of the first embodiment, an article to be carried by the carrier device 1 is first described. The carrier device 1 of the first embodiment is to carry an article, and the article to be carried includes feet 52. With reference to FIG. 6A to FIG. 6C, the article to be carried in the first embodiment is a box 50. The box 50 is an exterior member of a server device, having accommodated therein an electronic device that configures a server. Casters 51 are each provided at a lower end of the box 50. The casters 51 are provided at four corners of the box 50. Also, the box 50 includes the feet 52 each at the lower end. The feet 52 are provided at the four corners of the box 50. Each foot 52 includes a shaft member 52a and a disk-shaped grounding unit 52b. The shaft member 52a includes a screw unit, which is screwed into a screw unit provided inside the box 50. A projection amount of the shaft member 52a from the box 50 can be changed by adjusting a screwed state of the screw units. When the box 50 is installed at a predetermined location, the projection amount of the shaft member 52a from the box 50 can be increased so that the foot 52 projects to a degree equal to or lower than a lower end of the caster 51. With this, the grounding unit 52b of the foot 52 is grounded on a floor surface, thereby causing the box 50 to be installed at the predetermined location. On the other hand, when the box 50 is carried, the projection amount of the shaft member 52a from the box 50 is decreased to cause the foot 52 to be away from the floor surface. The carrier device 1 carries the box 50 in this state.

Next, a schematic structure of the carrier device 1 is described with reference to the drawings. Note that a height direction, a width direction, a front and rear direction, and a left and right direction of the carrier device 1 in the following description are assumed to be those depicted in FIG. 1, FIG. 2A, and FIG. 2B.

The carrier device 1 includes the main body unit 2 provided with a handle unit 3. The main body unit 2 is formed by combining a plurality of rod-shaped members. The handle unit 3 is provided at the highest position of the main body unit 2. The carrier device 1 includes engaging units 10 that each engage with the foot 52 provided at the lower end of the box 50 as an article to be carried. Specifically, each engaging unit 10 is provided to the main body unit 2 via the arm member 5 provided to a lateral member 4 provided at the lowest side (the lower end) of the main body unit 2.

The lateral member 4 includes a guide groove 4a extending along an axial direction (a width direction) of this lateral member 4. In this guide groove 4a, two arm members 5 are attached. The guide groove 4a corresponds to a position adjusting unit of the arm members 5, and the arm members 5 are slidably inserted in the guide groove 4a and are fixed to the lateral member 4 by using fixing metal fittings 6 and fixing screws 7. The arm members 5 can be slid with respect to the guide groove 4a and is position-adjustable, and therefore a space between these two arm members 5 can be adjusted. The space between these two arm members 5 is adjusted correspondingly to a space between the feet 52 provided to the box 50 to be carried. At an end on a side of each arm member 5 opposite to a side attached to the guide groove 4a, a mount plate 9 where the engaging unit 10, which will be described in detail further below, is attached is mounted. The mount plate 9 is provided with bolts 9a.

The carrier device 1 includes two engaging units 10. These two engaging units 10 are each mounted on the mount plate 9 attached at an end of the arm member 5. With reference to FIG. 3, the engaging unit 10 includes a front side plate 10a. The front side plate 10a is provided with two screw grooves 10a1 extending in a height direction. These screw grooves 10a1 correspond to a height adjusting unit for the engaging unit 10 with respect to the main body unit 2, and the bolts 9a included in the mount plate 9 are inserted into the screw grooves 10a1. By adjusting a relative position of the bolts 9a with respect to the screw grooves 10a1 and tightening nuts 9b, the height of the engaging unit 10 can be adjusted. The engaging unit 10 includes a rear side plate 10b at a position facing the front side plate 10a. The engaging unit 10 also includes a right side plate 10c and a left side plate 10d. The engaging unit 10 further includes a bottom plate 10e in an area surrounded by these front side plate 10a, rear side plate 10b, right side plate 10c, and left side plate 10d. The front side plate 10a, the rear side plate 10b, the right side plate 10c, and the left side plate 10d correspond to an abutting unit where the grounding unit 52b abuts. Also, the bottom plate 10e corresponds to a bottom where the feet 52 are mounted at the time of towing. The bottom is not restricted to the bottom plate, and can be any as long as the feet 52 are mountable. The engaging unit 10 includes guide plates 11 extending from the front side plate 10a on an upper side of the right side plate 10c and the left side plate 10d. The guide plates 11 can be used as a mark for the operator when inserting each engaging unit 10 into a lower side of the foot 52, which will be described in detail further below.

With reference to FIG. 4, a wedge-shaped angle adjusting plate 12 including an inclined surface 12a is accommodated in the engaging unit 10. The angle adjusting plate 12 is an example of an angle adjusting member. The angle adjusting plate 12 is used in consideration with the fact that the main body unit 2 is tilted when the box 50 is towed by the carrier device 1 and the bottom plate 10e of each engaging unit 10 is tilted from a horizontal state accordingly. The bottom of the grounding unit 52b of the foot 52 is normally in a horizontal state. The angle adjusting plate 12 can improve stability of the grounding unit 52b mounted on the engaging unit 10. A plurality of angle adjusting plates 12 can be used. Also, a plurality of angle adjusting plates 12 with the inclined surfaces having same and different angles can be prepared and used in combination as appropriate according to the use state of the carrier device 1 and the state of each foot 52. Also, the angle adjusting member can have any shape as long as it has a portion approximately horizontal at the time of towing, the portion where the foot 52 can be mounted and supported.

The carrier device 1 includes two casters 8 provided to the main body unit 2. Specifically, the carrier device 1 includes the casters 8 each attached to a lower side of the arm member 5. The casters 8 of the first embodiment are wheel-shaped casters, but may be ball-shaped casters. The casters 8 can freely change the traveling direction of the carrier device 1. The arm member 5 includes a guide groove 5a extending in a front and rear direction. The caster 8 is attached to the guide groove 5a via a fixing plate 8a provided on an upper part, and is fixed to the arm member 5 by using the fixing metal fittings 6 and the fixing screws 7. The carrier device 1 can include an additional caster to be attached to the lateral member 4.

Next, the use state of the carrier device 1 as described above is described with reference to FIGS. 6A to 10.

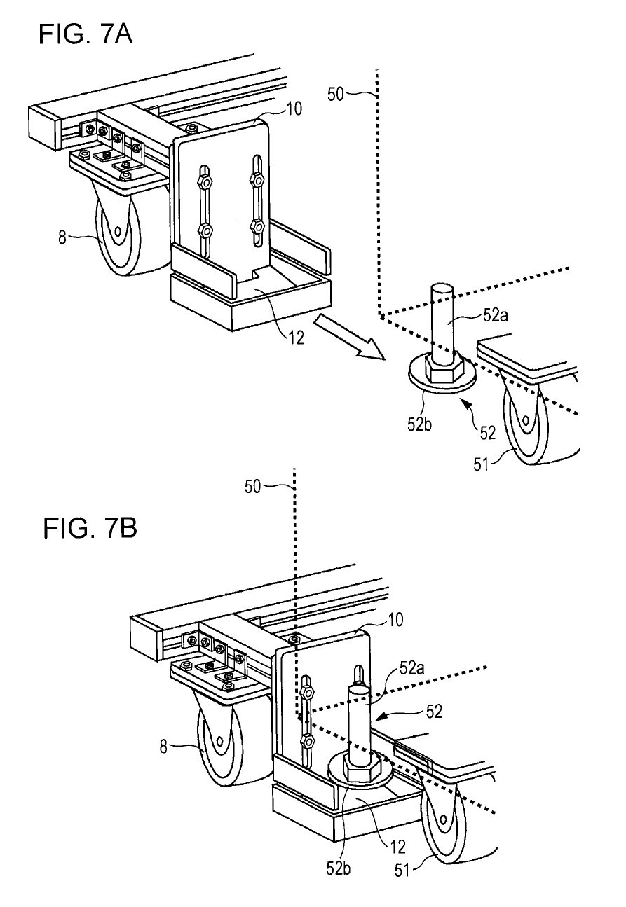

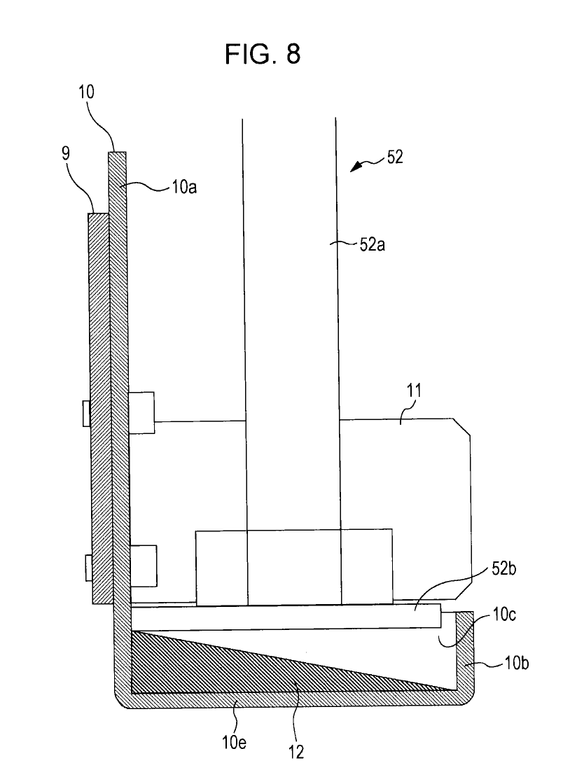

When the box 50 is carried, the space between the arm members 5 is first adjusted according to the space between the feet 52 included in the box 50. The space between the arm members 5 can be adjusted by sliding the arm members 5 each with respect to the guide groove 4a. The arm members 5 are assumed to be positioned symmetrically with respect to a center line of the main body unit 2. Also, the feet 52 are raised so as to be away from the floor surface. Then, as depicted in FIG. 6A and FIG. 7A, the carrier device 1 is set at a position on a front side of the box 50. Here, the carrier device 1 is placed so that the main body unit 2 is along a vertical direction, that is, the engaging unit 10 is approximately in parallel with a lower end edge of the box 50. Then, as depicted in FIG. 6B and FIG. 7C, the carrier device 1 is moved toward the box 50, and each engaging unit 10 is inserted into a lower side of the foot 52. When the engaging unit 10 is inserted into the lower side of the foot 52, the operator can move the carrier device 1 by taking the guide plates 11 as a guide. Then, the height of the engaging unit 10 may be adjusted, as occasion culls. The height is adjusted so that, as depicted in FIG. 8, part of the grounding unit 52b is in contact with the angle adjusting plate 12. The height of the engaging unit 10 may be adjusted in advance. In this case, the handle unit 3 is slightly tilted toward a box 50 side in order to avoid interference between the rear side plate 10b and the grounding unit 52b, thereby moving the carrier device 1 toward the box 50 side while tilting the engaging units 10.

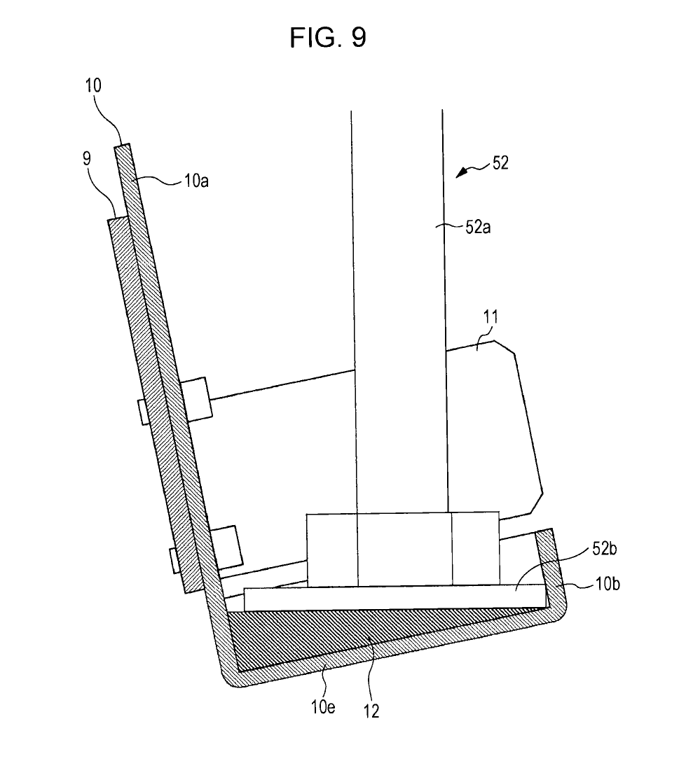

In the case where the engaging unit 10 is placed on the lower side of the grounding unit 52b as depicted in FIG. 8, when the operator pulls the handle unit 3 to his or her side as depicted in FIG. 6C, the carrier device 1 becomes tilted with the caster 8 as a fulcrum. Accordingly, as depicted in FIG. 9, a lower surface of the grounding unit 52b becomes in intimate contact with the inclined surface 12a of the angle adjusting plate 12. Also, the foot 52 is mounted on the engaging unit 10. From this state, when the operator moves the carrier device 1, the rear side plate 10b and the grounding unit 52b are engaged with each other, and therefore the box 50 becomes in a towed state (proceeds forward). To move the box 50 to right, the operator operates the handle unit 3 to move the carrier device 1 to right in the traveling direction. With this, the grounding unit 52b is pressed by the left side plate 10d, thereby moving the box 50 to right. To move the box 50 to left, the operator operates the handle unit 3 to move the carrier device 1 to left in the traveling direction. With this, the grounding unit 52b is pressed by the right side plate 10c, thereby moving the box 50 to left. In this manner, the operator can easily steer the box 50 by operating the carrier device 1 by holding the handle unit 3. Note that by using the carrier device 1, the box 50 can be caused to proceed backward. When the box 50 proceeds backward, the relation between the grounding unit 52b and the engaging unit 10 is as depicted in FIG. 8, that is, the grounding unit 52b is pushed by the front side plate 10a. With this, the box 50 can be caused to proceed backward.

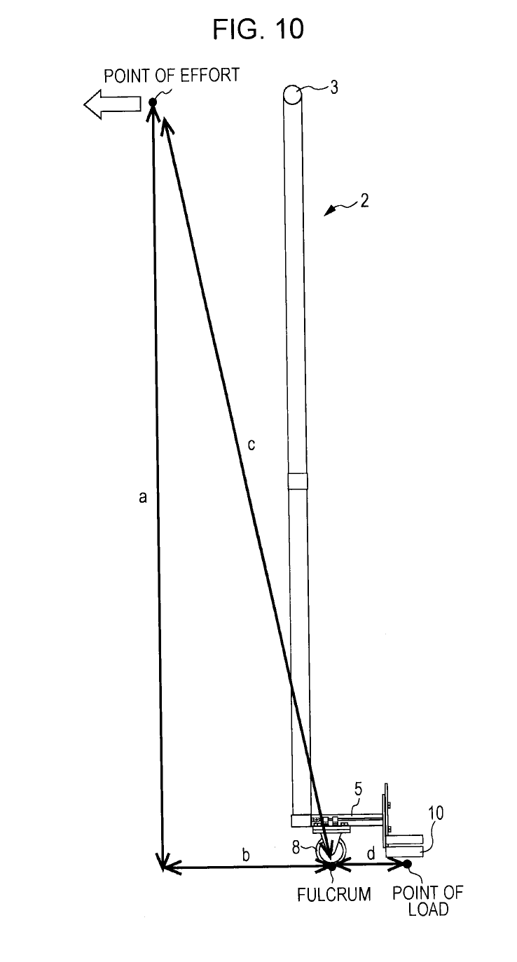

Here, an example of a fulcrum, a point of effort, and a point of load and a dynamic relation when the box 50 is carried by using the carrier device 1 is described with reference to FIG. 10. Note that calculations below are approximate and are not strictly performed.

First, the dimensions of each component and the weight of the box 50 to be carried by the carrier device 1 are assumed as follows.

A vertical distance a from the fulcrum (the grounding point of the caster 8) to the point of effort (the handle unit 3): a=1425 mm

A horizontal distance b from the fulcrum (the grounding point of the caster 8) to the point of effort (the handle unit 3): b=120 mm

A horizontal distance d from the fulcrum (the grounding point of the caster 8) to the point of load (the engaging unit 10): d=90 mm

Box weight: 600 kg

Under the assumption as described above, a distance c from the fulcrum to the point of effort is

$$\begin{matrix}\begin{matrix}{c}^{2} = {a}^{2} + {b}^{2} \\ = {1425}^{2} + {120}^{2}\end{matrix} & \\ c = 1430 ( mm ) . & \end{matrix}$$

When the box weight is 600 kg, the weight loaded on a box front side where the carrier device 1 is mounted can be 300 kg.

From these conditions described above, a traction A is approximately calculated as:

$$\begin{matrix}A \times 1430 = 300 \times 90 & \\ \begin{matrix}A = ( 300 \times 90 ) / 1430 \\ = 18.8 kg .\end{matrix} & \end{matrix}$$

That is, by towing with a force of approximately 18.8 kg, a front end side of the box 50 can be lifted. That is, the weight of the box 50 can be shared in a distributed manner. Furthermore, by towing with a force exceeding 18.8 kg, the box 50 can be easily moved, and steering the box 50 can be facilitated.

The carrier device 1 as described above can be used without the box 50 being mounted on a cart or the like. Also, by using the carrier device 1, the operator can carry the box 50 without using an oil-hydraulic lifter. In the case where the box 50 is lifted by using an oil-hydraulic lifter, if the oil-hydraulic lifer is placed at an erroneous location with respect to the box 50, a local load is added to the box 50 to deform the box 50. With the use of the carrier device 1 of the first embodiment, the possibility of deforming the box 50 can be reduced. When the box 50 is placed on a cart or the like, the box 50 is once lifted. However, the box 50 may not be able to be lifted when a restriction in a height direction is present in the location where the box 50 is to be placed. With the use of the carrier device 1, the box 50 can be moved and placed even if a restriction in a height direction is present in the location where the box 50 is to be placed. The carrier device 1 has a weight lighter than the oil-hydraulic lifter, and is easy to handle.

Also, when the box 50 is moved by man power, two or more persons are needed. However, with the use of the carrier device 1, the box 50 can be carried only by one person. When the box 50 is placed at a narrow location, if two or more persons are engaged in a carrying operation, some persons are difficult to position. This problem can be solved by using the carrier device 1. Furthermore, since the box 50 can be moved without attaching hands on the outer wall surfaces of the box 50, decorative laminate boards forming the outer walls of the box 50 are not dented. Still further, since the operator can carry the box 50 with the carrier device 1 being pulled mainly forward, the possibility that the operator himself or herself topples can be reduced. That is, when the box 50 is carried with hands attached on the outer wall surfaces of the box 50, the operator positioned on a traveling direction side dangerously moves backward. With the use of the carrier device 1, the operator can move and steer as facing forward.

Note in the carrier device 1 that the arm members 5 and the casters 8 can be removed from the main body unit 2. By being disassembled, the carrier device 1 can be easily accommodated and stored for space saving. For example, the main body unit 2 may be accommodated inside doors of the box 50. The main body unit 2 accommodated in the doors can reinforce the box 50.

### Second Embodiment

Next, a second embodiment is described. The second embodiment is different from the first embodiment in the following points. That is, in the second embodiment, engaging units 20 are provided in place of the engaging units 10 of the first embodiment. Other components in the second embodiment are similar to the components of the first embodiment, and therefore these common components are provided with the same reference characters and are not described in detail herein.

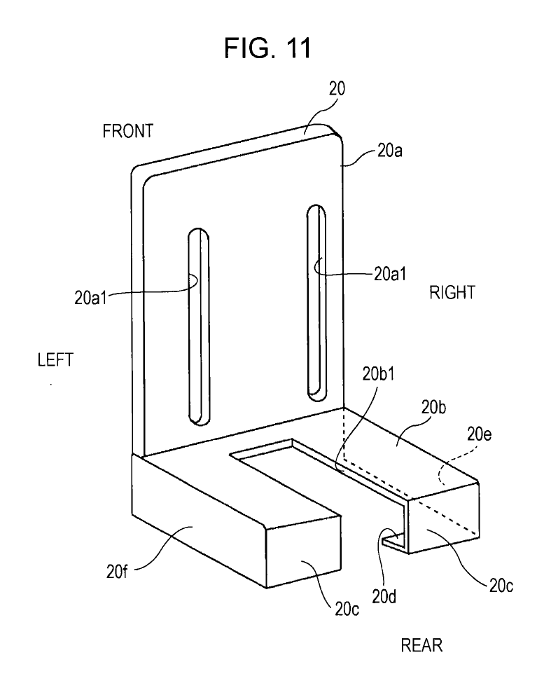

The engaging unit 20 is mounted on the arm member 5 in place of the engaging unit 10 of the first embodiment. With reference to FIG. 11, the engaging unit 20 includes a front side plate 20a. The front side plate 20a is provided with two screw grooves 20a1 extending in a height direction. As with the engaging unit 10 of the first embodiment, the bolts 9a included in the mount plate 9 are inserted into the screw grooves 20a1. By adjusting a relative position of the bolts 9a with respect to the screw grooves 20a1 and tightening nuts 9b, the height of the engaging unit 20 can be adjusted. The engaging unit 20 includes a top plate 20b. This top plate 20b is connected to a rear side plate 20c facing the front side plate 20a. Furthermore, the rear side plate 20c is connected to a bottom plate 20d. The top plate 20b is provided with a groove 20b1 avoiding an interference with the shaft member 52a included in the foot 52. The groove 20b1 continues to the rear side plate 20c and the bottom plate 20d. The engaging unit 20 includes a right side plate 20e and a left side plate 20f. The front side plate 20a, the rear side plate 20c, the right side plate 20e, and the left side plate 20f correspond to an abutting unit where the grounding unit 52b abuts. That is, the abutting unit includes the rear side plate 20c connecting the top plate 20b and the bottom plate 20d. Also, the bottom plate 20d corresponds to a bottom where the foot 52 is mounted at the time of towing. The bottom is not restricted to the bottom plate, but can be any as long as the bottom allows the foot 52 to be mounted. Note that when the box 50 is moved in a left and right direction, steering can be performed with the shaft member 52a of the foot 52 being in contact with the groove 20b1. For this reason, the structure can be such that the right side plate 20e and the left side plate 20f are omitted.

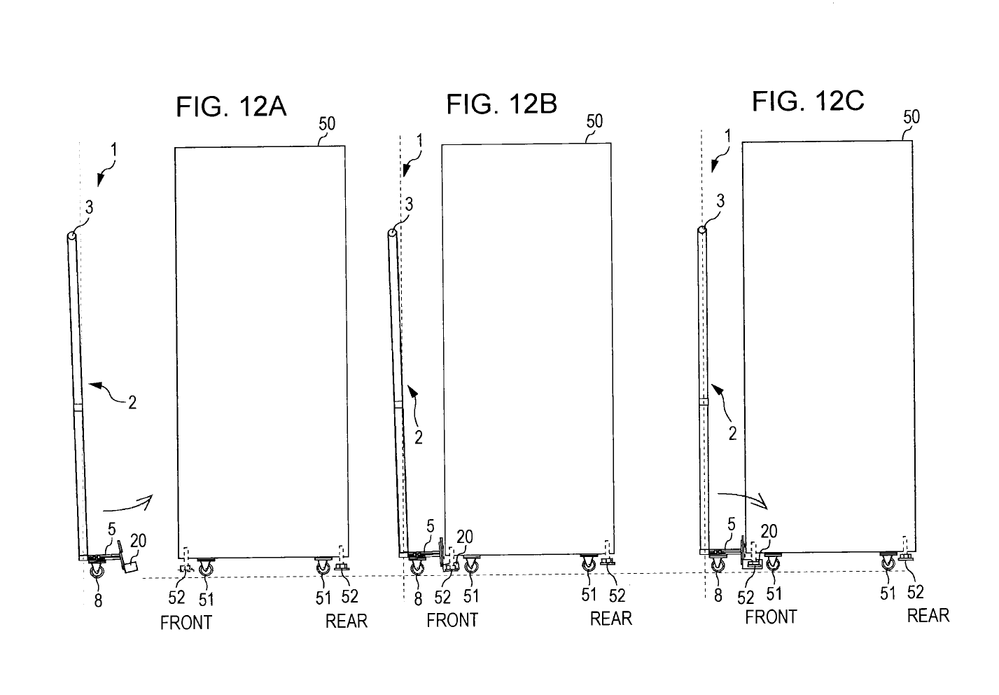

Next, the use state of the second embodiment is described with reference to FIGS. 12A to 14.

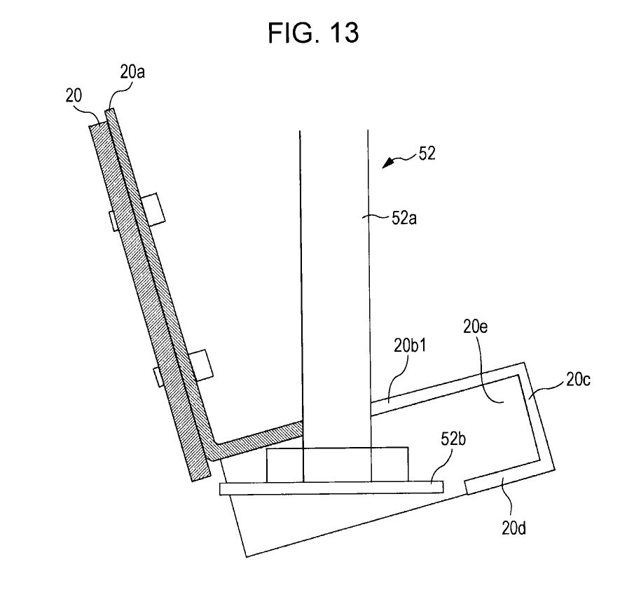

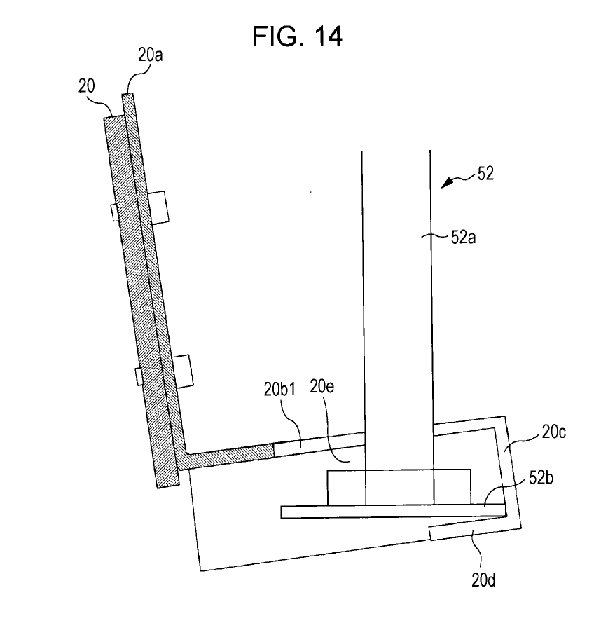

When the box 50 is carried, the space between the arm members 5 is first adjusted according to the space between the feet 52 included in the box 50. Here, the feet 52 are raised and away from the floor surface. This is the same as the first embodiment. Then, as depicted in FIG. 12A, the carrier device 1 is positioned on a front side of the box 50. Here, the main body unit 2 is tilted forward from a vertical direction so that the engaging unit 20 is slightly raised. Then, as depicted in FIG. 12B, with the tilt of the main body unit 2 being kept, the carrier device 1 is moved toward the box 50, and the shaft member 52a of the foot 52 is positioned inside the groove 20b1. With this, as depicted in FIG. 13, the engaging unit 20 becomes in the state as covering from above the grounding unit 52b. Then, as depicted in FIG. 12C, the carrier device 1 is once raised straight so that the main body unit 2 is vertical. With this, the grounding unit 52b is positioned above the bottom plate 20d. Then, when the carrier device 1 is slightly pulled forward, as depicted in FIG. 14, the grounding unit 52b is mounted on the bottom plate 20d. By towing the carrier device 1 in this state, the box 50 can be moved.

To move the box 50 to right, the operator operates the handle unit 3 to move the carrier device 1 to right in the traveling direction. With this, the grounding unit 52b is pressed by the left side plate 20f and the shaft member 52a is in contact with the groove 20b1, thereby moving the box 50 to right. To move the box 50 to left, the operator operates the handle unit 3 to move the carrier device 1 to left in the traveling direction. With this, the grounding unit 52b is pressed by the right side plate 20e and the shaft member 52a is in contact with the groove 20b1, thereby moving the box 50 to left. In this manner, the operator can easily steer the box 50 by operating the carrier device 1 by holding the handle unit 3.

As in the second embodiment, moving and steering the box 50 can be performed also by using the engaging units 20.

### Third Embodiment

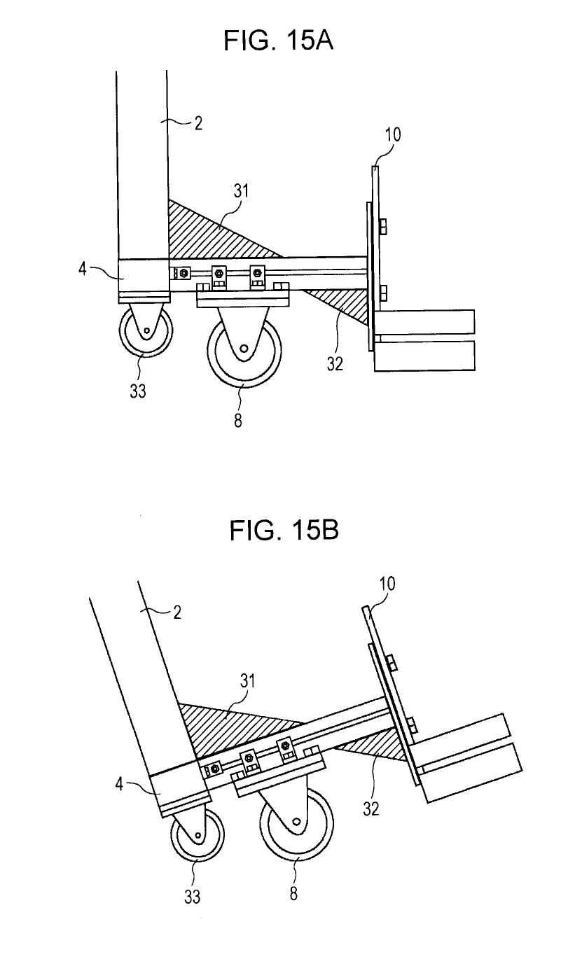

Next, a third embodiment is described with reference to FIG. 15A and FIG. 15B. The third embodiment is an example in which reinforcing members 31 and 32 and an auxiliary caster 33 is provided. The reinforcing member 31 is placed between the arm member 5 and the main body unit 2. In this case, the main body unit 2 can include a fixing unit for the reinforcing member 31 to support the movement of the arm member 5 in a left and right direction. The reinforcing member 32 is placed between the arm member 5 and the mount plate 9. With the provision of the reinforcing members 31 and 32, the strength of the carrier device 1 is improved.

The auxiliary caster 33 is mounted on a lower side of the lateral member 4. With the provision of the auxiliary caster 33, the carrying device 1 is less prone to topple. Also, with the auxiliary caster 33 being grounded at the time of towing, more stable towing can be performed. If a caster in a ball shape is adopted as the auxiliary caster 33, a contact with the floor surface is a point contact to reduce friction, thereby improving operability.

The preferred embodiments have been described in detail thus far. However, embodiments of the present disclosure are not limited to the specified embodiments and various alteration and modification may occur within a scope of the present disclosure described in the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A carrier device comprising:
a main body provided;
a handle provided to the main body;
an engaging unit provided to the main body and configured to be engaged with a foot provided at a lower end of an article to be carried; and
a caster provided to the main body.

2. The carrier device according to claim 1,
wherein the engaging unit is provided to the main body via an arm member provided at a lower end of the main body.

3. The carrier device according to claim 2, further comprising:
a position adjusting unit for the arm member with respect to the main body.

4. The carrier device according to claim 1, further comprising:
a height adjusting unit for the engaging unit with respect to the main body.

5. The carrier device according to claim 1,
wherein the engaging unit includes a bottom where a grounding part of the foot is mounted at the time of towing, and an abutting part configured to abut on the grounding part.

6. The carrier device according to claim 5,
wherein the abutting part includes a back side plate configured to abut on the abutting part, a right side plate, and a left side plate.

7. The carrier device according to claim 5, further comprising:
an angle adjusting member to be placed on the bottom.

8. The carrier device according to claim 7,
wherein a plurality of the angle adjusting members are placed on the bottom.

9. The carrier device according to claim 1,
wherein the engaging unit includes a bottom where a grounding part of the foot is mounted at the time of towing, an abutting part configured to abut on the ground unit, and a top plate configured to have a groove to avoid an interference with a shaft member of the foot.

10. The carrier device according to claim 9,
wherein the abutting part includes a rear side plate connecting the top plate and the bottom.

11. A method for carrying an article by using a carrier device, the method comprising:
engaging an engaging part of the carrier device that includes a handle and a carrier with a foot provided at a lower end of an article to be carried; and
operating the carrier device by holding the handle, thereby towing and steering the article to be carried.

12. The method according to claim 11,
wherein the foot and the engaging part are engaged in a state in which the foot is mounted on the engaging part by inserting the engaging part into a lower side of the foot and then pulling the handle forward, thereby tilting the carrier device with the caster being taken as a fulcrum.
